(19) United States
(12) Patent Application Publication
(10) Pub. No.: US 2026/0227889 A1
(43) Pub. Date: Aug. 6, 2026

(54) INFORMATION DISPLAY CONTROL METHOD, ELECTRONIC DEVICE, AND NON-TRANSITORY COMPUTER-READABLE STORAGE MEDIUM

(71) Applicant: Beijing Zitiao Network Technology Co., Ltd., Beijing (CN)

(72) Inventors: Minyu FANG, Sydney (AU); Yan ZHANG, Beijing (CN); Changqing HONG, Beijing (CN)

(21) Appl. No.: 19/150,912

(22) PCT Filed: Jun. 18, 2024
(86) PCT No.: PCT/CN2024/099706

§ 371 Date: Jul. 25, 2025

(30) Foreign Application Priority Data
Jul. 25, 2023 (CN) 202310922966.X

(51) Int. Cl. G06F 3/0484; G06Q 30/0241

(52) U.S. Cl. CPC G06F 3/0484; G06Q 30/0241

(57) ABSTRACT

An information display control method, electronic device, and non-transitory computer-readable storage medium are provided. The information display control method includes: determining a current random probability based on a current timestamp in a preset time dimension, the current random probability being a pseudo-random probability generated at a current moment; acquiring a current trigger probability corresponding to a target user within a current time cycle, the current trigger probability being acquired by updating a previous trigger probability corresponding to the target user within a previous time cycle based on anchor information display data and trigger data within a previous time cycle; and comparing the current random probability with the current trigger probability, and controlling, based on a comparison result, whether to display anchor information of a second object on a displayed first object, the anchor information being information triggerable by the target user to display the second object.

The present application claims priority to Chinese Patent Application No. 202310922966.X filed on Jul. 25, 2023, which is incorporated herein by reference in its entirety as a part of the present application.

### TECHNICAL FIELD

Embodiments of the present disclosure relate to an information display control method and apparatus, a device, and a storage medium.

### BACKGROUND

With the rapid development of computer technologies, when a user watches an object, a different object may be recommended to the user by displaying anchor information of the different object on the object. For example, when a user watches a video, anchor information of an advertisement application (App) may be displayed on the video, and the user may trigger the anchor information through clicking or in another manner and download the advertisement App. However, the anchor information is displayed every time the video is watched, and such frequent display disturbs the user unduly, causing user disgust and reducing the watching experience of the user. It can be learned that there is an urgent need for a method that can be used to dynamically control anchor information display.

### SUMMARY

The present disclosure provides an information display control method and apparatus, a device, and a storage medium, to implement dynamic control of anchor information display, thereby avoiding undue disturbance to a user while increasing a trigger rate of anchor information, and improving the user experience.

According to a first aspect, an embodiment of the present disclosure provides an information display control method. The information display control method includes:
in response to that a trigger condition for an anchor information display is currently satisfied, determining a current random probability based on a current timestamp in a preset time dimension, the current random probability being a pseudo-random probability generated at a current moment;
acquiring a current trigger probability corresponding to a target user within a current time cycle, the current trigger probability being acquired by updating a previous trigger probability corresponding to the target user within a previous time cycle based on anchor information display data and trigger data within the previous time cycle; and
comparing the current random probability with the current trigger probability, and controlling, based on a comparison result, whether to display anchor information of a second object on a displayed first object, the anchor information being information triggerable by the target user to display the second object.

According to a second aspect, an embodiment of the present disclosure further provides an information display control apparatus. The information display control apparatus includes:
a current random probability determination module, configured to determine a current random probability based on a current timestamp in a preset time dimension, in response to that a trigger condition for an anchor information display is currently satisfied, the current random probability being a pseudo-random probability generated at a current moment;
a current trigger probability acquisition module, configured to acquire a current trigger probability corresponding to a target user within a current time cycle, the current trigger probability being acquired by updating a previous trigger probability corresponding to the target user within a previous time cycle based on anchor information display data and trigger data within the previous time cycle; and
an anchor information display control module, configured to compare the current random probability with the current trigger probability, and control, based on a comparison result, whether to display anchor information of a second object on a displayed first object the anchor information being information triggerable by the target user to display the second object.

According to a third aspect, an embodiment of the present disclosure further provides an electronic device. The electronic device includes:
one or more processors; and
a storage apparatus configured to store one or more programs, where
the one or more programs, when executed by the one or more processors, cause the one or more processors to implement the information display control method according to any one of the embodiments of the present disclosure.

According to a fourth aspect, an embodiment of the present disclosure further provides a storage medium containing computer-executable instructions, where the computer-executable instructions, when executed by a computer processor, are used to perform the information display control method according to any one of the embodiments of the present disclosure.

### BRIEF DESCRIPTION OF DRAWINGS

The foregoing and other features, advantages, and aspects of embodiments of the present disclosure become more apparent with reference to the following specific implementations and accompanying drawings. Throughout the accompanying drawings, the same or similar reference numerals denote the same or similar elements. It should be understood that the accompanying drawings are schematic and that parts and elements are not necessarily drawn to scale.

FIG. 1 is a schematic flowchart of an information display control method according to an embodiment of the present disclosure;

FIG. 2 is a schematic flowchart of another information display control method according to an embodiment of the present disclosure;

FIG. 3 is a schematic flowchart of still another information display control method according to an embodiment of the present disclosure;

FIG. 4 is a schematic structural diagram of an information display control apparatus according to an embodiment of the present disclosure; and

FIG. 5 is a schematic structural diagram of an electronic device according to an embodiment of the present disclosure.

### DETAILED DESCRIPTION

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include” and variants thereof used herein indicate open inclusion, that is, “include but are not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

It can be understood that the data involved in the technical solutions (including, but not limited to, the data itself and the access to or use of the data) shall comply with the requirements of corresponding laws, regulations, and relevant provisions.

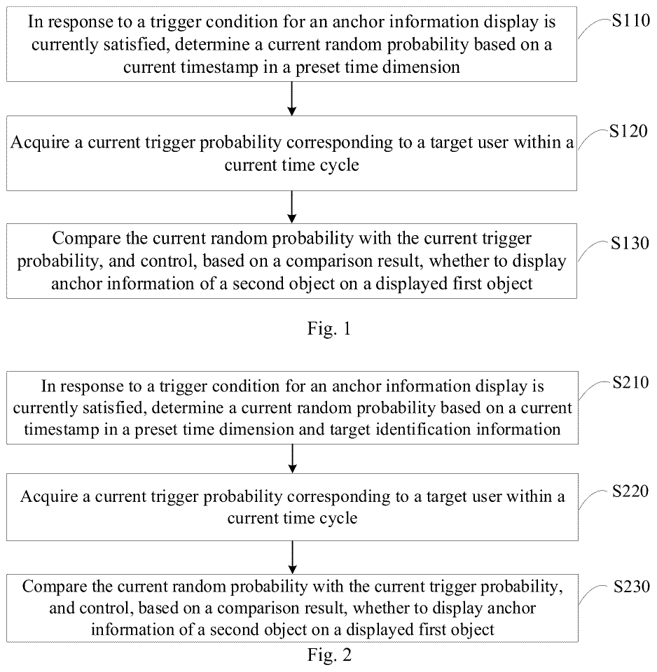

FIG. 1 is a schematic flowchart of an information display control method according to an embodiment of the present disclosure. This embodiment of the present disclosure is applicable to the situation where dynamic control is carried out for the display of anchor information, and the method may be performed by an information display control apparatus. The apparatus may be implemented in the form of software and/or hardware. Optionally, the apparatus is implemented by an electronic device, and the electronic device may be a mobile terminal, a PC, a server, or the like.

As shown in FIG. 1, the information display control method specifically includes the following steps.

S110: In response to a trigger condition for an anchor information display is currently satisfied, determine a current random probability based on a current timestamp in a preset time dimension.

The anchor information, also referred to as named anchor information, is a type of hyperlink information used to link a specified object, so that a user triggers anchor information through clicking or in another manner to view the specified object. The trigger condition for the anchor information display may be a trigger condition that is preset based on business requirements, and that needs a determination of whether to display anchor information of a second object on a first object. The first object may be any object that the user watches actively. For example, the first object may be a video, music, an article, etc. The second object may be any object recommended to the user. For example, the second object may be an advertisement APP, etc. The trigger condition for the anchor information display may be associated with the display of the first object, so as to trigger the judgement on whether to display the anchor information at a specific time. For example, the trigger condition for the anchor information display may include, but is not limited to, one of the following: triggering when requesting to display the first object, triggering when starting to display the first object, and triggering when a scheduled time period is reached during the display of the first object. Triggering when requesting to display the first object means triggering the judgement on whether to display the anchor information when it is requested to display the first object. Triggering when starting to display the first object means triggering the judgement on whether to display the anchor information when the first object starts to display. Triggering when a scheduled time period is reached during the display of the first object means triggering the judgement on whether to display the anchor information when the scheduled time period is reached during the display of the first object, for example, when the display reaches 1 minute.

The preset time dimension may be a second-level dimension, a minute-level dimension, an hour-level dimension, etc. The current timestamp is a timestamp of a current moment in the preset time dimension. For example, if the current moment is 9:50:31 on Jul. 7, 2023, and the preset time dimension is the hour-level dimension, the current moment in the preset time dimension is 9 o'clock on Jul. 7, 2023, and the corresponding current timestamp is: 16XX691600. The current random probability may be a pseudo-random probability generated at the current moment, that is, a random probability generated by a computer algorithm, which is not truly random.

Specifically, a client may detect in real time whether the trigger condition for the anchor information display is currently satisfied, for example, whether the client currently requests to display the first object, whether the first object currently starts to display, or whether the scheduled time period is currently reached during the display of the first object. If it is detected that the trigger condition for the anchor information display is currently satisfied, it may be allowable to display the anchor information, but whether to ultimately display the anchor information needs to be determined by triggering a subsequent determination operation. If it is detected that the trigger condition for the anchor information display is not currently satisfied, it may be directly determined that display of the anchor information is not allowed, without a need to trigger the subsequent determination operation, so that display of the anchor information is allowed only at a specific moment.

In response to that the trigger condition for the anchor information display is currently satisfied, the subsequent determination operation is specifically: acquiring the current timestamp in the preset time dimension and converting the current timestamp to a corresponding current random probability, thereby reducing randomness of random probability generation to some extent. Because the current timestamp changes dynamically over time, the random probability determined each time also changes dynamically. For example, it is possible that the random probability determined this time is greater or less than the random probability determined last time. It should be noted that, the current timestamp in the preset time dimension is converted to the corresponding current random probability, so the random probabilities determined every time in the same time dimension are the same, thereby facilitating troubleshooting. In addition, results of determining whether to display the anchor information in the same time dimension are also consistent, thereby optimizing the watching experience of the user. For example, if the preset time dimension is the hour-level dimension, the timestamps within the same hour are the same, so that the random probabilities determined within the same hour are the same, and results of determining whether to display the anchor information within the same hour based on the same random probability are also the same. For example, within an hour from 9 o'clock to 10 o'clock, the anchor information is ultimately displayed after each trigger, or the anchor information is not displayed after each trigger, thereby ensuring the consistency of user watching within a short time.

For example, the “determining a current random probability based on a current timestamp in a preset time dimension” in step S110 may include: performing modulo processing on the current timestamp in the preset time dimension based on a preset number of probability precision digits, to determine the current random probability.

The preset number of probability precision digits is preset based on business requirements, and indicates a number of precision digits of a probability value. For example, if the preset number of probability precision digits is 2, the probability value has precision of two digits after the decimal point, such as 0.92, that is, 92%. If the preset number of probability precision digits is 4, the probability value has precision of four digits after the decimal point, such as 0.9211, that is, 92.11%. A larger preset number of probability precision digits indicates a higher precision of information display control.

Specifically, a parameter value for modulo processing is determined based on the preset number of probability precision digits. For example, if the preset number of probability precision digits is 2, the parameter value is 100, and if the preset number of probability precision digits is 4, the parameter value is 10,000. The current timestamp in the preset time dimension is divided by the parameter value for modulo processing (that is, remainder calculation), to determine a remainder less than the parameter value, and the remainder is converted to a probability value between 0 and 1, thereby acquiring the current random probability corresponding to the current timestamp. For example, if the current timestamp in the hour-level dimension is: 16XX691600, and the parameter value is 10,000, the remainder is 1,600, and the determined current random probability is: 0.1600, that is, 16.00%.

S120: Acquire a current trigger probability corresponding to a target user within a current time cycle.

For example, the time cycle may be an update cycle of a user trigger probability that is preset based on business requirements. For example, the time cycle may be every day or every hour. The current time cycle is a time cycle in which the current moment is located. The target user may be a user currently logging in to the client. The current trigger probability may be a probability of the target user triggering anchor information within the current time cycle, such as a click probability of the anchor information. A greater the current trigger probability indicates a higher likelihood that the target user is to trigger the anchor information within the current time cycle, and in this case, the likelihood of displaying the anchor information is also higher, so as to increase a trigger rate of the anchor information. The current trigger probability is acquired by updating a previous trigger probability corresponding to the target user within a previous time cycle based on anchor information display data and trigger data within the previous time cycle. It should be noted that the trigger probability corresponding to a first time cycle may be set to 100%, that is, displayed with a probability of 100%, so that the trigger probability is periodically dynamically updated based on actual data of the user later, thereby achieving precise control.

Specifically, the client may update the previous trigger probability corresponding to the target user within the previous time cycle based on the anchor information display data and the trigger data within the previous time cycle, thereby acquiring the current trigger probability corresponding to the target user within the current time cycle. Alternatively, a timing task starts in a server, to periodically acquire the anchor information display data and the trigger data of the target user within the previous time cycle, the previous trigger probability corresponding to the target user within the previous time cycle is updated based on the data, to acquire the current trigger probability corresponding to the target user within the current time cycle, and the current trigger probability is stored in a database, so that the client directly acquires the current trigger probability corresponding to the current time cycle from the database, thereby saving computing resources of the client, and increasing the speed of information display control. It should be noted that because the trigger probabilities of all users need to be updated and maintained, to ensure real-time performance and online stability, all users may be divided into buckets, and all users in each bucket may be read and written uniformly, thereby achieving batch processing of the users and reducing a number of times of database writes.

S130: Compare the current random probability with the current trigger probability, and control, based on a comparison result, whether to display anchor information of a second object on a displayed first object.

The anchor information is the information that is triggerable by the target user to display the second object. After anchor information of the second object is displayed on the first object, if the target user is interested in the displayed anchor information, trigger may be performed by clicking the anchor information to jump to a specified position to display detailed information of the second object, so that the user can quickly view the second object and perform corresponding processing, such as downloading an APP of the second object.

Specifically, the current random probability is compared with the current trigger probability, and whether to display the anchor information of the second object on the displayed first object is determined based on whether the comparison result is that the current random probability is less than or equal to the current trigger probability or the current random probability is greater than the current trigger probability, thereby achieving dynamic control of anchor information display, such as displaying the anchor information this time and not displaying the anchor information next time, so as to avoid undue disturbance to the user.

For example, step S130 may include: controlling to display the anchor information of the second object on the displayed first object, in response to that the current random probability is less than or equal to the current trigger probability; or controlling not to display the anchor information of the second object on the displayed first object, in response to that the current random probability is greater than the current trigger probability.

For example, the current trigger probability is 90%, and based on the current trigger probability of 90%, a probability range of 0 to 1 may be divided into 2 segments, which are 0% to 90% and 90% to 100%, respectively. Although the current random probability is randomly generated, the likelihood that the current random probability is in the range of 0% to 90% is higher than the likelihood that the current random probability is in the range of 90% to 100%. In view of this, when the current random probability is in the range of 0% to 90%, that is, less than or equal to the current trigger probability, it may be determined to display the anchor information. When the current random probability is within the range of 90% to 100%, that is, greater than the current trigger probability, it is determined not to display the anchor information. Moreover, a greater current trigger probability leads to a higher likelihood that the determined current random probability is to be less than or equal to the current trigger probability, and thus leads to a higher likelihood that the anchor information is to be displayed. Thus, when the target user is more likely to trigger the anchor information, the anchor information is more likely to be displayed, thereby avoiding undue disturbance to the user while increasing the trigger rate of the anchor information, and improving the user experience.

According to the technical solution in the embodiment of the present disclosure, in response to that the trigger condition for the anchor information display is currently satisfied, the current random probability is determined based on the current timestamp in the preset time dimension, and the current trigger probability corresponding to the target user within the current time cycle is acquired, the current trigger probability being acquired by updating the previous trigger probability corresponding to the target user within the previous time cycle based on the anchor information display data and the trigger data generated within the previous time cycle, so that different users can correspond to different trigger probabilities, and the trigger probability is periodically dynamically updated based on the data of the previous period, ensuring the precision of the user trigger probability. The greater the current trigger probability corresponding to the target user indicates the higher likelihood that the anchor information is to be displayed at the current time. The current random probability is compared with the current trigger probability, and whether to display the anchor information of the second object on the displayed first object may be determined based on the comparison result, thereby achieving dynamic control of anchor information display, avoiding undue disturbance to the user while increasing the trigger rate of the anchor information, and improving the user experience.

FIG. 2 is a schematic flowchart of another information display control method according to an embodiment of the present disclosure. On the basis of the embodiments disclosed above, this embodiment of the present disclosure optimizes the step of “determining a current random probability based on a current timestamp in a preset time dimension”. Explanations of the terms identical or corresponding to those in the embodiments disclosed above are not repeated herein.

As shown in FIG. 2, the information display control method specifically includes the following steps.

S210: In response to a trigger condition for an anchor information display is currently satisfied, determine a current random probability based on a current timestamp in a preset time dimension and target identification information.

The target identification information may be the information uniquely identified by a value. For example, the target identification information may include: at least one of target user identification information or first object identification information. The target user identification information may be a target user ID uniquely identified by a value to distinguish various users. The first object identification information may be a first object ID uniquely identified by a value to distinguish various first objects. For example, both of the target user identification information and the first object identification information may be uniquely represented by a 64-bit binary number.

Specifically, in response to that the trigger condition for the anchor information display is currently satisfied, a subsequent determination operation is specifically as follows: acquiring a current timestamp in a preset time dimension, and processing the current timestamp and the target identification information, such as adding up the values of the current timestamp and the target identification information to obtain a target value after the addition, and converting the target value to a corresponding current random probability, so that the current random probability can be determined for a specific user or first object, which further achieves dynamic control of information display, and reduces the randomness of random probability generation.

For example, the “determining a current random probability based on a current timestamp in a preset time dimension and target identification information” in step S210 may include: performing binary XOR processing on the current timestamp in the preset time dimension and the target identification information to obtain a target value after the processing; and determining the current random probability based on the target value.

Specifically, in the situation that the target identification information is only the target user identification information, the current timestamp in the preset time dimension may be converted to a corresponding binary number, and the target user identification information may also be converted to a corresponding binary number. Bitwise XOR processing is performed on the binary current timestamp and the target user identification information to acquire an XOR-processed binary number, and the XOR-processed binary number is converted to a decimal target value. Modulo processing is performed on the target value based on a preset number of probability precision digits, so as to determine the current random probability, so that the current random probability matched with the user can be determined, that is, under the same timestamp, various users may correspond to different random probabilities, and random probabilities determined for the same user in the same time dimension are the same, which facilitates troubleshooting, and explains whether to ultimately display the information.

In the situation that the target identification information is only the first object identification information, the current timestamp in the preset time dimension may be converted to a corresponding binary number, and the first object identification information may also be converted to a corresponding binary number. Bitwise XOR processing is performed on the binary current timestamp and the first object identification information to acquire an XOR-processed binary number, and the XOR-processed binary number is converted to a decimal target value. Modulo processing is performed on the target value based on a preset number of probability precision digits, so as to determine the current random probability, so that the current random probability matched with the first object can be determined, that is, under the same timestamp, various first objects may correspond to different random probabilities, and random probabilities determined for the same first object in the same time dimension are the same, which facilitates troubleshooting, and explains whether to ultimately display the information.

In the situation that the target identification information is the target user identification information and the first object identification information, the current timestamp in the preset time dimension may be converted to a corresponding binary number, the target user identification information may also be converted to a corresponding binary number, and the first object identification information may also be converted to a corresponding binary number. Bitwise XOR processing is performed on the binary current timestamp, the target user identification information, and the first object identification information to acquire an XOR-processed binary number, and the XOR-processed binary number is converted to a decimal target value. Modulo processing is performed on the target value based on a preset number of probability precision digits, so as to determine the current random probability, so that the current random probability matched with both the user and the first object can be determined, that is, under the same timestamp, various users or various first objects may correspond to different random probabilities, and random probabilities determined for the same user and the same first object in the same time dimension are the same, which facilitates troubleshooting, and explains whether to ultimately display the information.

A specific process of performing modulo processing on the target value is consistent with a specific process of performing modulo processing on the current timestamp in the preset time dimension in the above embodiment. The process is specifically as follows: A parameter value for modulo processing is determined based on the preset number of probability precision digits. For example, if the preset number of probability precision digits is 2, the parameter value is 100, and if the preset number of probability precision digits is 4, the parameter value is 10,000. The target value is divided by the parameter value for modulo processing (that is, remainder calculation), to determine a remainder less than the parameter value, and the remainder is converted to a probability value between 0 and 1, thereby acquiring the current random probability corresponding to the target value. For example, if the target value is: 327986917865, and the parameter value is 10,000, the remainder is 7,865, and the determined current random probability is: 0.7865, that is, 78.65%.

S220: Acquire a current trigger probability corresponding to a target user within a current time cycle.

S230: Compare the current random probability with the current trigger probability, and control, based on a comparison result, whether to display anchor information of a second object on a displayed first object.

According to the technical solution in this embodiment of the present disclosure, in response to that the trigger condition for the anchor information display is currently satisfied, the current timestamp in the preset time dimension and the target identification information are processed to determine the current random probability, so that the matched current random probability can be determined for a specific user or a first object, thereby further achieving dynamic control of information display, reducing the randomness of random probability generation, and ensuring precise frequency control of information display.

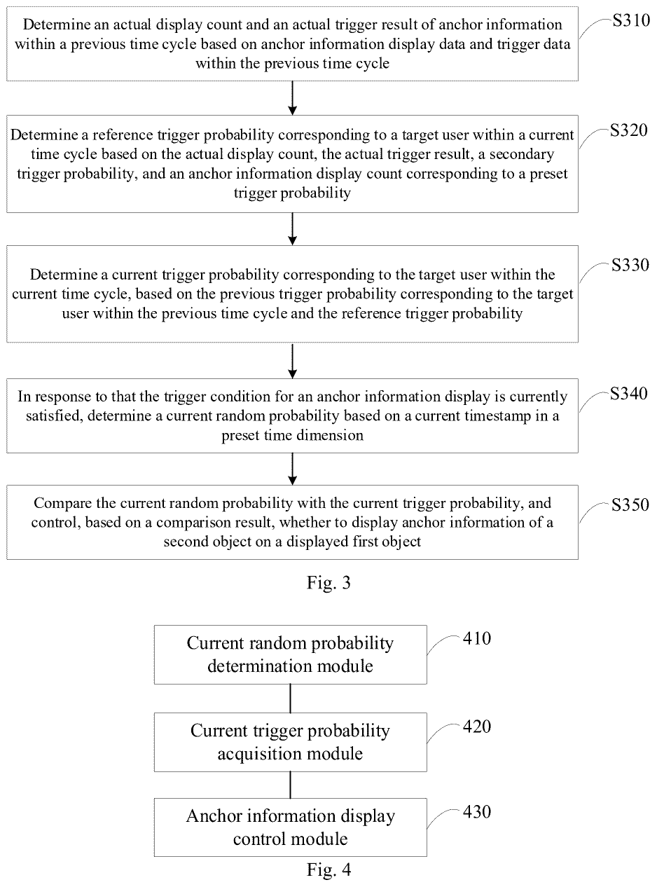

FIG. 3 is a schematic flowchart of still another information display control method according to an embodiment of the present disclosure. On the basis of the embodiments disclosed above, this embodiment of the present disclosure describes in detail a specific update process of the current trigger probability. Explanations of the terms identical or corresponding to those in the embodiments disclosed above are not repeated herein.

As shown in FIG. 3, the information display control method specifically includes the following steps.

S310: Determine an actual display count and an actual trigger result of anchor information within a previous time cycle based on anchor information display data and trigger data within the previous time cycle.

Specifically, the anchor information display data and the trigger data of a target user within the previous time cycle may be collected. An actual display count N of the anchor information within the previous time cycle may be counted based on the anchor information display data. An actual trigger result of whether the target user triggers the anchor information within the previous time cycle may be determined based on the trigger data of the target user. Because the user may or may not trigger the anchor information displayed within the previous time cycle, the actual trigger result may be that there is no trigger within the previous time cycle (for example, the anchor information is not clicked), or may be that there is a trigger within the previous time cycle (for example, the anchor information is clicked).

S320: Determine a reference trigger probability corresponding to a target user within a current time cycle based on the actual display count, the actual trigger result, a secondary trigger probability, and an anchor information display count corresponding to a preset trigger probability.

The preset trigger probability may be a trigger probability preset based on business requirements. There may be one or more preset trigger probabilities. For example, there are two preset trigger probabilities, which are 90% and 95%, respectively. The anchor information display count corresponding to each preset trigger probability means that a user trigger probability within the display count is the preset trigger probability. For example, the anchor information display count corresponding to the preset trigger probability of 90% is 100, that is, the anchor information is displayed for 100 times, and the user has a 90% probability of triggering the anchor information. The anchor information display count corresponding to each preset trigger probability may be preset and determined based on historical display data and historical trigger data. For example, the actual display count with triggering occurs for all users within one time cycle are acquired, and these actual display counts are sorted in descending order. The actual display count located at a 90% position in the order is determined as the anchor information display count corresponding to the preset trigger probability of 90%. A greater the preset trigger probability leads to a more corresponding anchor information display count. For example, the anchor information display count corresponding to the preset trigger probability of 90% is 100, and the anchor information display count corresponding to the preset trigger probability of 95% is 150.

The secondary trigger probability is a preset probability that there are triggers both within the previous time cycle and the current time cycle. The secondary trigger probability may alternatively be preset and determined based on the historical display data and the historical trigger data. For example, the secondary trigger probability may be 0.1, that is, 10%. The reference trigger probability corresponding to the target user within the current time cycle may be the reference trigger probability for determining whether the target user will trigger within the current time cycle, which is determined based on an actual display situation and an actual trigger situation within the previous time cycle.

Specifically, the reference trigger probability corresponding to the target user within the current time cycle may be determined based on whether there is a trigger within the previous time cycle. For example, if there is a trigger within the previous time cycle, it indicates that a target user trigger probability within the current time cycle is low, that is, the determined reference trigger probability is low. If there is no trigger within the previous time cycle, it indicates that the target user trigger probability within the current time cycle is high, that is, the determined reference trigger probability is high, thereby matching an actual trigger situation of the user.

For example, step S320 may include: in response to that the actual trigger result is that there is a trigger within the previous time cycle, determining the reference trigger probability corresponding to the target user within the current time cycle based on the actual display count, the secondary trigger probability, and the anchor information display count corresponding to the preset trigger probability.

Specifically, in response to that there is a trigger within the previous time cycle, the secondary trigger probability may be determined as the reference trigger probability corresponding to the target user within the current time cycle; or, the reference trigger probability may be determined based on the actual display count and the anchor information display count corresponding to the preset trigger probability.

For example, the determining the reference trigger probability corresponding to the target user within the current time cycle based on the actual display count, the secondary trigger probability, and the anchor information display count corresponding to the preset trigger probability may include: determining a candidate trigger probability based on the actual display count and the anchor information display count corresponding to the preset trigger probability; and comparing the candidate trigger probability with the secondary trigger probability to determine the reference trigger probability corresponding to the target user within the current time cycle.

Specifically, if there is only one preset trigger probability, a ratio between the actual display count and the anchor information display count corresponding to the preset trigger probability is determined as the candidate trigger probability. If there are at least two preset trigger probabilities, a ratio between the actual display count and the anchor information display count corresponding to a maximum preset trigger probability is determined as the candidate trigger probability. For example, if there are two preset trigger probabilities, which are 90% and 95%, respectively, a ratio between the actual display count and the anchor information display count corresponding to the preset trigger probability of 95% is determined as the candidate trigger probability. The candidate trigger probability is compared with the secondary trigger probability, and the minimum one of the two trigger probabilities is used as the reference trigger probability corresponding to the target user within the current time cycle. For example, if the candidate trigger probability is 20% and the secondary trigger probability is 10%, the reference trigger probability is determined to be 10%, so that the determined reference trigger probability does not exceed the secondary trigger probability in the situation that there is a trigger within the previous time cycle.

For example, step S320 may further include: in response to that the actual trigger result is that there is no trigger within the previous time cycle, determining the reference trigger probability corresponding to the target user within the current time cycle based on the actual display count, a preset penalty probability, and the anchor information display count corresponding to the preset trigger probability.

The preset penalty probability is the penalty probability of no trigger within the previous time cycle. A higher preset penalty probability indicates a faster trigger probability decrease. For example, the preset penalty probability is 10%.

Specifically, in the situation that there is no trigger within the previous time cycle, the actual display count may be compared with the anchor information display count corresponding to the preset trigger probability, and the reference trigger probability is determined based on a comparison result. For example, in the situation that there is only one preset trigger probability, if the actual display count is less than or equal to the anchor information display count corresponding to the preset trigger probability, a result of subtracting the preset penalty probability from 1 may be used as the reference trigger probability. If the actual display count is greater than the anchor information display count corresponding to the preset trigger probability, a ratio of the anchor information display count corresponding to the preset trigger probability divided by the preset trigger probability may be determined as the reference trigger probability. In the situation that there is no trigger within the previous time cycle, the utilization of one preset trigger probability may be divided into two cases, the first case is: the actual display count is less than or equal to the anchor information display count corresponding to the preset trigger probability; and the second case is: the actual display count is greater than the anchor information display count corresponding to the preset trigger probability, and the reference trigger probability (i.e., a first reference trigger probability) determined in the first case is greater than the reference trigger probability (i.e., a second reference trigger probability) determined in the second case, thereby achieving the effect of stage-by-stage decrease.

For example, in the situation that there are only two preset trigger probabilities, and the actual trigger result is that there is no trigger within the previous time cycle, the first reference trigger probability determined in a first case is greater than the second reference trigger probability determined in a second case, and the second reference trigger probability determined in the second case is greater than the reference trigger probability (i.e., a third reference trigger probability) determined in a third case. The first case represents the situation where the actual display count is less than or equal to the first anchor information display count corresponding to a first preset trigger probability; the second case represents the situation where the actual display count is greater than the first anchor information display count and less than the second anchor information display count corresponding to a second preset trigger probability; and the third case represents the situation where the actual display count is greater than or equal to the second anchor information display count, thereby achieving the effect of stage-by-stage decrease.

For example, in the situation that there are only two preset trigger probabilities, for example, the first anchor information display count corresponding to the first preset trigger probability of 90% is 100, and the second anchor information display count corresponding to the second preset trigger probability of 95% is 150, the determining the reference trigger probability corresponding to the target user within the current time cycle based on the actual display count, a preset penalty probability, and the anchor information display count corresponding to the preset trigger probability may include:

In response to that the actual display count is less than or equal to the first anchor information display count corresponding to the first preset trigger probability, using a result of subtracting the preset penalty probability from 1 as the reference trigger probability corresponding to the target user within the current time cycle;

In response to that the actual display count is greater than the first anchor information display count and less than the second anchor information display count corresponding to the second preset trigger probability, using a result of dividing the first anchor information display count by the actual display count as the reference trigger probability corresponding to the target user within the current time cycle; and

In response to that the actual display count is greater than or equal to the second anchor information display count, adding up the first anchor information display count and the actual display count to acquire a total display count, and using a result of dividing the first anchor information display count by the total display count as the reference trigger probability corresponding to the target user within the current time cycle.

In the situation that there is no trigger within the previous time cycle, the utilization of two preset trigger probabilities may be divided into the above three cases. The first case is: the actual display count is less than or equal to the first anchor information display count of 100; the second case is: the actual display count is greater than or equal to the first anchor information display count of 100 and less than the second anchor information display count of 150; and the third case is: the actual display count is greater than or equal to the second anchor information display count of 150. Moreover, the first reference trigger probability determined in the first case is greater than the second reference trigger probability determined in the second case, and the second reference trigger probability determined in the second case is greater than the third reference trigger probability determined in the third case, thereby achieving the effect of stage-by-stage decrease, and the division may be finer to improve control precision. Similarly, if there are three preset trigger probabilities, the utilization of three preset trigger probabilities may be divided into four cases, and the reference trigger probability determined in each case is decreased stage by stage.

S330: Determine a current trigger probability corresponding to the target user within the current time cycle, based on the previous trigger probability corresponding to the target user within the previous time cycle and the reference trigger probability.

Specifically, the current trigger probability corresponding to the target user within the current time cycle may be acquired by performing weighted summation on the previous trigger probability and the reference trigger probability, thereby achieving periodic update of the user trigger probability.

It should be noted that the current trigger probability fluctuates; in other words, the current trigger probability may be greater than the previous trigger probability, or may be less than the previous trigger probability, thereby achieving dynamic control of anchor information display.

For example, step S330 may include: decaying the reference trigger probability based on a preset decaying factor to acquire a decayed reference trigger probability; and performing weighted summation on the previous trigger probability corresponding to the target user within the previous time cycle and the decayed reference trigger probability to acquire the current trigger probability corresponding to the target user within the current time cycle.

The preset decaying factor may be a preset probability decaying factor greater than 1. A greater preset decaying factor indicates a faster decrease. Especially when the probability value is small, the decrease is greater. For example, the preset decaying factor is 2. A weight value corresponding to the previous trigger probability is β. The larger the weight value, the lower a change speed. For example, the weight value β is 0.5. The weight value corresponding to the reference trigger probability is 1−β.

Specifically, the current trigger probability P corresponding to the target user within the current time cycle may be determined by using a formula

$$P = β {P}_{0} + ( 1 - β ) {P}_{1}^{α} ,$$

where P₀ is the previous trigger probability corresponding to the target user within the previous time cycle, and P₁ is the reference trigger probability corresponding to the target user within the current time cycle.

S340: In response to that the trigger condition for an anchor information display is currently satisfied, determine a current random probability based on a current timestamp in a preset time dimension.

S350: Compare the current random probability with the current trigger probability, and control, based on a comparison result, whether to display anchor information of a second object on a displayed first object.

According to the technical solution in this embodiment of the present disclosure, the actual display count and the actual trigger result of the anchor information within the previous time cycle are determined based on the anchor information display data and the trigger data within the previous time cycle, and the reference trigger probability corresponding to the target user within the current time cycle is determined based on the actual display count, the actual trigger result, the anchor information display count corresponding to the preset trigger probability, and the secondary trigger probability, thereby achieving periodic update of the user trigger probability, and ensuring precise control of anchor information display.

FIG. 4 is a schematic structural diagram of an information display control apparatus according to an embodiment of the present disclosure. As shown in FIG. 4, the apparatus specifically includes: a current random probability determination module 410, a current trigger probability acquisition module 420, and an anchor information display control module 430.

The current random probability determination module 410 is configured to determine a current random probability based on a current timestamp in a preset time dimension, in response to that a trigger condition for an anchor information display is currently satisfied, the current random probability being a pseudo-random probability generated at a current moment. The current trigger probability acquisition module 420 is configured to acquire a current trigger probability corresponding to a target user within a current time cycle, the current trigger probability being acquired by updating a previous trigger probability corresponding to the target user within a previous time cycle based on anchor information display data and trigger data within the previous time cycle. The anchor information display control module 430 is configured to compare the current random probability with the current trigger probability, and control, based on a comparison result, whether to display anchor information of a second object on a displayed first object, the anchor information being information triggerable by the target user to display the second object.

According to the technical solution provided in this embodiment of the present disclosure, in response to that the trigger condition for the anchor information display is currently satisfied, the current random probability is determined based on the current timestamp in the preset time dimension, and the current trigger probability corresponding to the target user within the current time cycle is acquired, the current trigger probability being acquired by updating the previous trigger probability corresponding to the target user within the previous time cycle based on the anchor information display data and the trigger data generated within the previous time cycle, so that various users can correspond to different trigger probabilities, and the trigger probability is periodically dynamically updated based on the data of the previous period, thereby ensuring the precision of a user trigger probability. The greater the current trigger probability corresponding to the target user, the higher the likelihood that the anchor information is to be displayed at the current time. The current random probability is compared with the current trigger probability, and whether to display the anchor information of the second object on the displayed first object may be determined based on the comparison result, thereby achieving dynamic control of anchor information display, avoiding undue disturbance to the user while increasing the trigger rate of the anchor information, and improving the user experience.

On the basis of the above technical solutions, the current random probability determination module 410 is specifically configured to:
perform modulo processing on the current timestamp in the preset time dimension based on a preset number of probability precision digits, to determine the current random probability.

On the basis of the above technical solutions, the current random probability determination module 410 is specifically configured to:
determine the current random probability based on the current timestamp in the preset time dimension and target identification information.

The target identification information includes: at least one of target user identification information or first object identification information.
on the basis of the above technical solutions, the current random probability determination module 410 is specifically configured to:
perform binary XOR processing on the current timestamp in the preset time dimension and the target identification information to acquire a processed target value; and determine the current random probability based on the target value.

On the basis of the above technical solutions, the apparatus further includes: a trigger probability update module.

The trigger probability update module includes:
an actual information determination sub-module, configured to determine an actual display count and an actual trigger result of the anchor information within the previous time cycle based on the anchor information display data and the trigger data within the previous time cycle;
a reference trigger probability determination sub-module, configured to determine a reference trigger probability corresponding to a target user within the current time cycle based on the actual display count, the actual trigger result, a secondary trigger probability, and an anchor information display count corresponding to a preset trigger probability, where the secondary trigger probability is a preset probability that there are triggers both within the previous time cycle and the current time cycle; and
a current trigger probability determination sub-module, configured to determine the current trigger probability corresponding to the target user within the current time cycle based on the previous trigger probability corresponding to the target user within the previous time cycle and the reference trigger probability.

On the basis of the above technical solutions, the reference trigger probability determination sub-module includes:
a first determination unit, configured to determine the reference trigger probability corresponding to the target user within the current time cycle based on the actual display count, the secondary trigger probability, and the anchor information display count corresponding to the preset trigger probability, in response to that the actual trigger result is that there is a trigger within the previous time cycle; and
a second determination unit configured to determine the reference trigger probability corresponding to the target user within the current time cycle based on the actual display count, a preset penalty probability, and the anchor information corresponding to the preset trigger probability, in response to that the actual trigger result is that there is no trigger within the previous time cycle.

On the basis of the above technical solutions, the first determination unit is specifically configured to:
determine a candidate trigger probability based on the actual display count and the anchor information display count corresponding to the preset trigger probability; and compare the candidate trigger probability with the secondary trigger probability to determine the reference trigger probability corresponding to the target user within the current time cycle.

On the basis of the above technical solutions, in response to that the actual trigger result is that there is no trigger within the previous time cycle, a first reference trigger probability determined in a first case is greater than a second reference trigger probability determined in a second case, and the second reference trigger probability determined in the second case is greater than a third reference trigger probability determined in a third case;
the first case represents the situation that the actual display count is less than or equal to a first anchor information display count corresponding to a first preset trigger probability;
the second case represents the situation that the actual display count is greater than the first anchor information display count and less than a second anchor information display count corresponding to a second preset trigger probability; and
the third case represents the situation that the actual display count is greater than or equal to the second anchor information display count.

On the basis of the above technical solutions, the current trigger probability determination sub-module is specifically configured to:
decrease the reference trigger probability based on a preset decaying factor to acquire a decayed reference trigger probability; and perform weighted summation on the previous trigger probability corresponding to the target user within the previous time cycle and the decayed reference trigger probability to acquire the current trigger probability corresponding to the target user within the current time cycle.

On the basis of the above technical solutions, the anchor information display control module 430 is specifically configured to:
control to display the anchor information of the second object on the displayed first object, in response to that the current random probability is less than or equal to the current trigger probability; and
control not to display the anchor information of the second object on the displayed first object, in response to that the current random probability is greater than the current trigger probability.

On the basis of the above technical solutions, the trigger condition for the anchor information display includes one of the following:
triggering in response to a request for displaying the first object, triggering in response to starting to display the first object, and triggering in response to that a scheduled time period is reached during the display of the first object.

The information display control apparatus provided in this embodiment of the present disclosure can perform the information display control method provided in any one of the embodiments of the present disclosure, and has corresponding functional modules and beneficial effects for performing the information display control method.

It is worth noting that the units and modules included in the above apparatus are acquired through division merely according to functional logic, but are not limited to the above division, as long as corresponding functions can be implemented. In addition, specific names of the functional units are merely used for mutual distinguishing, and are not used to limit the scope of protection of the embodiments of the present disclosure.

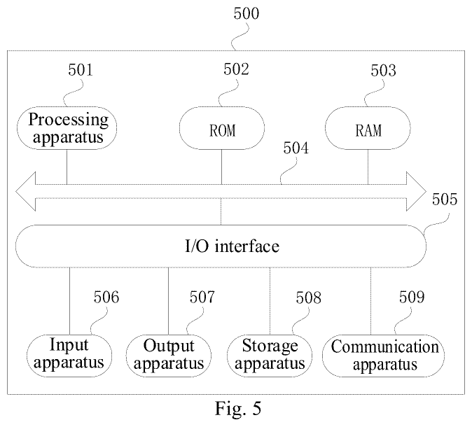

FIG. 5 is a schematic structural diagram of an electronic device according to an embodiment of the present disclosure. Reference is made to FIG. 5 below, which is a schematic structural diagram of an electronic device (such as a terminal device or a server in FIG. 5) 500 suitable for implementing embodiments of the present disclosure. A terminal device in this embodiment of the present disclosure may include, but is not limited to, mobile terminals such as a mobile phone, a notebook computer, a digital broadcast receiver, a personal digital assistant (PDA), a tablet computer (portable Android device, PAD), a portable media player (PMP), and a vehicle-mounted terminal (e.g., a vehicle navigation terminal), and fixed terminals such as a digital TV and a desktop computer. The electronic device shown in FIG. 5 is merely an example, and shall not impose any limitation on the function and scope of use of the embodiments of the present disclosure.

As shown in FIG. 5, the electronic device 500 may include a processing apparatus (for example, a central processing unit or a graphics processing unit) 501 that may perform a variety of appropriate actions and processing in accordance with a program stored in a read-only memory (ROM) 502 or a program loaded from a storage apparatus 508 into a random-access memory (RAM) 503. The RAM 503 further stores various programs and data required for the operation of the electronic device 500. The processing apparatus 501, the ROM 502, and the RAM 503 are connected to each other through a bus 504. An input/output (I/O) interface 505 is also connected to the bus 504.

Generally, the following apparatuses may be connected to the I/O interface 505: an input apparatus 506 including, for example, a touchscreen, a touchpad, a keyboard, a mouse, a camera, a microphone, an accelerometer, and a gyroscope; an output apparatus 507 including, for example, a liquid crystal display (LCD), a speaker, and a vibrator; the storage apparatus 508 including, for example, a tape and a hard disk; and a communication apparatus 509. The communication apparatus 509 may allow the electronic device 500 to perform wireless or wired communication with other devices to exchange data. Although FIG. 5 shows the electronic device 500 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, an embodiment of the present disclosure includes a computer program product, which includes a computer program carried on a non-transitory computer-readable medium, where the computer program includes program code for performing the method shown in the flowchart. In such an embodiment, the computer program may be downloaded from a network through the communication apparatus 509 and installed, installed from the storage apparatus 508, or installed from the ROM 502. When the computer program is executed by the processing apparatus 501, the above functions defined in the method of the embodiment of the present disclosure are performed.

The names of messages or information exchanged between a plurality of apparatuses in the implementations of the present disclosure are used for illustrative purposes only, and are not used to limit the scope of these messages or information.

The electronic device provided in this embodiment of the present disclosure and the information display control method provided in the above embodiments belong to the same inventive concept. For the technical details not exhaustively described in this embodiment, reference may be made to the above embodiments, and this embodiment and the above embodiments have the same beneficial effects.

An embodiment of the present disclosure provides a computer storage medium storing a computer program thereon, where the program, when executed by a processor, implements the information display control method provided in the above embodiments.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk, a random-access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as the Hypertext Transfer Protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to: determining a current random probability based on a current timestamp in a preset time dimension, when a trigger condition for an anchor information display is currently satisfied, the current random probability being a pseudo-random probability generated at a current moment; acquire a current trigger probability corresponding to a target user within a current time cycle, the current trigger probability being acquired by updating a previous trigger probability corresponding to the target user within a previous time cycle based on anchor information display data and trigger data within the previous time cycle; and compare the current random probability with the current trigger probability, and control, based on a comparison result. whether to display anchor information of a second object on a displayed first object, the anchor information being information triggerable by the target user to display the second object.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases, for example, a first acquisition unit may alternatively be described as “a unit for acquiring at least two Internet protocol addresses”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random-access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

According to one or more embodiments of the present disclosure, Example 1 provides an information display control method. The information display control method includes:
in response to a trigger condition for an anchor information display is currently satisfied, the current random probability being a pseudo-random probability generated at a current moment, determining a current random probability based on a current timestamp in a preset time dimension;
acquiring a current trigger probability corresponding to a target user within a current time cycle, the current trigger probability being acquired by updating a previous trigger probability corresponding to the target user within a previous time cycle based on anchor information display data and trigger data within the previous time cycle; and
compare the current random probability with the current trigger probability, and control, based on a comparison result, whether to display anchor information of a second object on a displayed first object, the anchor information being information triggerable by the target user to display the second object.

According to one or more embodiments of the present disclosure, Example 2 provides an information display control method. The information display control method further includes:
optionally, the determining a current random probability based on a current timestamp in a preset time dimension includes:
performing modulo processing on the current timestamp in the preset time dimension based on a preset number of probability precision digits, to determine the current random probability.

According to one or more embodiments of the present disclosure, Example 3 provides an information display control method. The information display control method further includes:
optionally, the determining a current random probability based on a current timestamp in a preset time dimension includes:
determining the current random probability based on the current timestamp in the preset time dimension and target identification information.

The target identification information includes: at least one of target user identification information or first object identification information.

According to one or more embodiments of the present disclosure, Example 4 provides an information display control method. The information display control method further includes:
optionally, the determining the current random probability based on the current timestamp in the preset time dimension and target identification information includes:
performing binary XOR processing on the current timestamp in the preset time dimension and the target identification information to acquire a processed target value; and
determining the current random probability based on the target value.

According to one or more embodiments of the present disclosure, Example 5 provides an information display control method. The information display control method further includes:
optionally, the acquiring a current trigger probability by updating a previous trigger probability corresponding to the target user within a previous time cycle based on anchor information display data and trigger data within the previous time cycle includes:
determining an actual display count and an actual trigger result of the anchor information within the previous time cycle based on the anchor information display data and the trigger data within the previous time cycle;
determining a reference trigger probability corresponding to a target user within the current time cycle based on the actual display count, the actual trigger result, a secondary trigger probability, and an anchor information display count corresponding to a preset trigger probability, where the secondary trigger probability is a preset probability that there are triggers both within the previous time cycle and the current time cycle; and
determining the current trigger probability corresponding to the target user within the current time cycle based on the previous trigger probability corresponding to the target user within the previous time cycle and the reference trigger probability.

According to one or more embodiments of the present disclosure, Example 6 provides an information display control method. The information display control method further includes:
optionally, the determining a reference trigger probability corresponding to a target user within the current time cycle based on the actual display count, the actual trigger result, a secondary trigger probability, and an anchor information display count corresponding to a preset trigger probability includes:
determining, in response to the actual trigger result is that there is a trigger within the previous time cycle, the reference trigger probability corresponding to the target user within the current time cycle, based on the actual display count, the secondary trigger probability, and the anchor information display count corresponding to the preset trigger probability; or
determining the reference trigger probability corresponding to the target user within the current time cycle based on the actual display count, a preset penalty probability, and the anchor information display count corresponding to the preset trigger probability, in response to that the actual trigger result is that there is no trigger within the previous time cycle.

According to one or more embodiments of the present disclosure, Example 7 provides an information display control method. The information display control method further includes:
optionally, the determining the reference trigger probability corresponding to the target user within the current time cycle based on the actual display count, the secondary trigger probability, and the anchor information display count corresponding to the preset trigger probability includes:
determining a candidate trigger probability based on the actual display count and the anchor information display count corresponding to the preset trigger probability; and
compare the candidate trigger probability with the secondary trigger probability to determine the reference trigger probability corresponding to the target user within the current time cycle.

According to one or more embodiments of the present disclosure, Example 8 provides an information display control method. The information display control method further includes:
optionally, in response to that the actual trigger result is that there is no trigger within the previous time cycle, a first reference trigger probability determined in a first case is greater than a second reference trigger probability determined in a second case, and the second reference trigger probability determined in the second case is greater than a third reference trigger probability determined in a third case;
the first case represents the situation that the actual display count is less than or equal to a first anchor information display count corresponding to a first preset trigger probability;
the second case represents the situation that the actual display count is greater than the first anchor information display count and less than a second anchor information display count corresponding to a second preset trigger probability; and
the third case represents the situation that the actual display count is greater than or equal to the second anchor information display count.

According to one or more embodiments of the present disclosure, Example 9 provides an
optionally, the determining the current trigger probability corresponding to the target user within the current time cycle based on the previous trigger probability corresponding to the target user within the previous time cycle and the reference trigger probability includes:
decaying the reference trigger probability based on a preset decaying factor to acquire a decayed reference trigger probability; and
performing weighted summation on the previous trigger probability corresponding to the target user within the previous time cycle and the decayed reference trigger probability to acquire the current trigger probability corresponding to the target user within the current time cycle.

According to one or more embodiments of the present disclosure, Example 10 provides an information display control method. The information display control method further includes:
optionally, the controlling, based on a comparison result, whether to display anchor information of a second object on a displayed first object includes:
control to display the anchor information of the second object on the displayed first object, in response to that the current random probability is less than or equal to the current trigger probability; or
control not to display the anchor information of the second object on the displayed first object, in response to that the current random probability is greater than the current trigger probability.

According to one or more embodiments of the present disclosure, Example 11 provides an information display control method. The information display control method further includes:
optionally, the trigger condition for the anchor information display includes one of the following:
triggering in response to a request for displaying the first object, triggering in response to starting to display the first object, and triggering in response to that a scheduled time period is reached during the display of the first object.

According to one or more embodiments of the present disclosure, Example 12 provides an information display control apparatus. The information display control apparatus includes:
a current random probability determination module, configured to determine a current random probability based on a current timestamp in a preset time dimension, in response to that a trigger condition for an anchor information display is currently satisfied, the current random probability being a pseudo-random probability generated at a current moment;
a current trigger probability acquisition module, configured to acquire a current trigger probability corresponding to a target user within a current time cycle, the current trigger probability being acquired by updating a previous trigger probability corresponding to the target user within a previous time cycle based on anchor information display data and trigger data within the previous time cycle; and
an anchor information display control module, configured to compare the current random probability with the current trigger probability, and control, based on a comparison result, whether to display anchor information of a second object on a displayed first object, the anchor information being information triggerable by the target user to display the second object.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. An information display control method, comprising:
determining, in response to that a trigger condition for an anchor information display is currently satisfied, a current random probability based on a current timestamp in a preset time dimension, the current random probability being a pseudo-random probability generated at a current moment;
acquiring a current trigger probability corresponding to a target user within a current time cycle, the current trigger probability being acquired by updating a previous trigger probability corresponding to the target user within a previous time cycle based on anchor information display data and trigger data within the previous time cycle; and
comparing the current random probability with the current trigger probability, and controlling, based on a comparison result, whether to display anchor information of a second object on a displayed first object, the anchor information being information triggerable by the target user to display the second object.

2. The information display control method according to claim 1, wherein the determining a current random probability based on a current timestamp in a preset time dimension comprises:
performing modulo processing on the current timestamp in the preset time dimension based on a preset number of probability precision digits, to determine the current random probability.

3. The information display control method according to claim 1, wherein the determining a current random probability based on a current timestamp in a preset time dimension comprises:
determining the current random probability based on the current timestamp in the preset time dimension and target identification information
wherein the target identification information comprises: at least one of target user identification information or first object identification information.

4. The information display control method according to claim 3, wherein the determining the current random probability based on the current timestamp in the preset time dimension and target identification information comprises:
performing binary XOR processing on the current timestamp in the preset time dimension and the target identification information to obtain a processed target value; and
determining the current random probability based on the processed target value.

5. The information display control method according to claim 1, wherein acquiring the current trigger probability by updating a previous trigger probability corresponding to the target user within the previous time cycle based on the anchor information display data and the trigger data within the previous time cycle comprises:
determining an actual display count and an actual trigger result of the anchor information within the previous time cycle, based on the anchor information display data and the trigger data within the previous time cycle;
determining a reference trigger probability corresponding to the target user within the current time cycle, based on the actual display count, the actual trigger result, a secondary trigger probability, and an anchor information display count corresponding to a preset trigger probability, wherein the secondary trigger probability is a preset probability that there is a trigger both within the previous time cycle and the current time cycle; and
determining the current trigger probability corresponding to the target user within the current time cycle, based on the previous trigger probability corresponding to the target user within the previous time cycle and the reference trigger probability.

6. The information display control method according to claim 5, wherein the determining a reference trigger probability corresponding to the target user within the current time cycle based on the actual display count, the actual trigger result, a secondary trigger probability, and an anchor information display count corresponding to a preset trigger probability comprises:
determining, in response to that the actual trigger result is that there is a trigger within the previous time cycle, the reference trigger probability corresponding to the target user within the current time cycle based on the actual display count, the secondary trigger probability, and the anchor information display count corresponding to the preset trigger probability; or
determining, in response to that the actual trigger result is that there is no trigger within the previous time cycle, the reference trigger probability corresponding to the target user within the current time cycle based on the actual display count, a preset penalty probability, and the anchor information display count corresponding to the preset trigger probability.

7. The information display control method according to claim 6, wherein the determining the reference trigger probability corresponding to the target user within the current time cycle based on the actual display count, the secondary trigger probability, and the anchor information display count corresponding to the preset trigger probability comprises:
determining a candidate trigger probability based on the actual display count and the anchor information display count corresponding to the preset trigger probability; and
comparing the candidate trigger probability with the secondary trigger probability to determine the reference trigger probability corresponding to the target user within the current time cycle.

8. The information display control method according to claim 6, wherein in response to that the actual trigger result is that there is no trigger within the previous time cycle, a first reference trigger probability determined in a first case is greater than a second reference trigger probability determined in a second case, and the second reference trigger probability determined in the second case is greater than a third reference trigger probability determined in a third case;
wherein the first case represents a situation where the actual display count is less than or equal to a first anchor information display count corresponding to a first preset trigger probability;
the second case represents a situation where the actual display count is greater than the first anchor information display count and less than a second anchor information display count corresponding to a second preset trigger probability; and
the third case represents a situation where the actual display count is greater than or equal to the second anchor information display count.

9. The information display control method according to claim 5, wherein the determining the current trigger probability corresponding to the target user within the current time cycle based on the previous trigger probability corresponding to the target user within the previous time cycle and the reference trigger probability comprises:
decaying the reference trigger probability based on a preset decaying factor to acquire a decayed reference trigger probability; and
performing weighted summation on the previous trigger probability corresponding to the target user within the previous time cycle and the decayed reference trigger probability to acquire the current trigger probability corresponding to the target user within the current time cycle.

10. The information display control method according to claim 1, wherein the controlling, based on a comparison result, whether to display anchor information of a second object on a displayed first object comprises:
controlling, in response to that the current random probability is less than or equal to the current trigger probability, to display the anchor information of the second object on the displayed first object;
controlling, in response to that the current random probability is less than or equal to the current trigger probability, not to display the anchor information of the second object on the displayed first object.

11. The information display control method according to claim 1, wherein the trigger condition for the anchor information display comprises one of the following:
triggering in response to a request for displaying the first object, triggering in response to starting to display the first object, and triggering in response to that a scheduled time period is reached during the display of the first object.

12. (canceled)

13. An electronic device, comprising:
one or more processors; and
a storage apparatus configured to store one or more programs, wherein
the one or more programs, when executed by the one or more processors, cause the one or more processors to implement an information display control method, wherein the information display control method comprises:
determining, in response to that a trigger condition for an anchor information display is currently satisfied, a current random probability based on a current timestamp in a preset time dimension, the current random probability being a pseudo-random probability generated at a current moment;
acquiring a current trigger probability corresponding to a target user within a current time cycle, the current trigger probability being acquired by updating a previous trigger probability corresponding to the target user within a previous time cycle based on anchor information display data and trigger data within the previous time cycle; and
comparing the current random probability with the current trigger probability, and controlling, based on a comparison result, whether to display anchor information of a second object on a displayed first object, the anchor information being information triggerable by the target user to display the second object.

14. A non-transitory computer-readable storage medium containing computer-executable instructions, wherein the computer-executable instructions, when executed by a computer processor, are used to perform a information display control method, wherein the information display control method comprises:
determining, in response to that a trigger condition for an anchor information display is currently satisfied, a current random probability based on a current timestamp in a preset time dimension, the current random probability being a pseudo-random probability generated at a current moment;
acquiring a current trigger probability corresponding to a target user within a current time cycle, the current trigger probability being acquired by updating a previous trigger probability corresponding to the target user within a previous time cycle based on anchor information display data and trigger data within the previous time cycle; and
comparing the current random probability with the current trigger probability, and controlling, based on a comparison result, whether to display anchor information of a second object on a displayed first object, the anchor information being information triggerable by the target user to display the second object.

15. The electronic device according to claim 13, wherein the determining a current random probability based on a current timestamp in a preset time dimension comprises:
performing modulo processing on the current timestamp in the preset time dimension based on a preset number of probability precision digits, to determine the current random probability.

16. The electronic device according to claim 13, wherein the determining a current random probability based on a current timestamp in a preset time dimension comprises:
determining the current random probability based on the current timestamp in the preset time dimension and target identification information
wherein the target identification information comprises: at least one of target user identification information or first object identification information.

17. The electronic device according to claim 16, wherein the determining the current random probability based on the current timestamp in the preset time dimension and target identification information comprises:
performing binary XOR processing on the current timestamp in the preset time dimension and the target identification information to obtain a processed target value; and
determining the current random probability based on the processed target value.

18. The electronic device according to claim 13, wherein acquiring the current trigger probability by updating a previous trigger probability corresponding to the target user within the previous time cycle based on the anchor information display data and the trigger data within the previous time cycle comprises:
determining an actual display count and an actual trigger result of the anchor information within the previous time cycle, based on the anchor information display data and the trigger data within the previous time cycle;
determining a reference trigger probability corresponding to the target user within the current time cycle, based on the actual display count, the actual trigger result, a secondary trigger probability, and an anchor information display count corresponding to a preset trigger probability, wherein the secondary trigger probability is a preset probability that there is a trigger both within the previous time cycle and the current time cycle; and
determining the current trigger probability corresponding to the target user within the current time cycle, based on the previous trigger probability corresponding to the target user within the previous time cycle and the reference trigger probability.

19. The electronic device according to claim 18, wherein the determining a reference trigger probability corresponding to the target user within the current time cycle based on the actual display count, the actual trigger result, a secondary trigger probability, and an anchor information display count corresponding to a preset trigger probability comprises:
in response to that the actual trigger result is that there is a trigger within the previous time cycle, determining the reference trigger probability corresponding to the target user within the current time cycle based on the actual display count, the secondary trigger probability, and the anchor information display count corresponding to the preset trigger probability; or
in response to that the actual trigger result is that there is no trigger within the previous time cycle, determining the reference trigger probability corresponding to the target user within the current time cycle based on the actual display count, a preset penalty probability, and the anchor information display count corresponding to the preset trigger probability.

20. The electronic device according to claim 19, wherein the determining the reference trigger probability corresponding to the target user within the current time cycle based on the actual display count, the secondary trigger probability, and the anchor information display count corresponding to the preset trigger probability comprises:
determining a candidate trigger probability based on the actual display count and the anchor information display count corresponding to the preset trigger probability; and
comparing the candidate trigger probability with the secondary trigger probability to determine the reference trigger probability corresponding to the target user within the current time cycle.

21. The electronic device according to claim 19, wherein in response to that the actual trigger result is that there is no trigger within the previous time cycle, a first reference trigger probability determined in a first case is greater than a second reference trigger probability determined in a second case, and the second reference trigger probability determined in the second case is greater than a third reference trigger probability determined in a third case;
wherein the first case represents a situation where the actual display count is less than or equal to a first anchor information display count corresponding to a first preset trigger probability;
the second case represents a situation where the actual display count is greater than the first anchor information display count and less than a second anchor information display count corresponding to a second preset trigger probability; and
the third case represents a situation where the actual display count is greater than or equal to the second anchor information display count.
